(19) United States
(12) Patent Application Publication
(10) Pub. No.: US 2012/0151065 A1
(43) Pub. Date: Jun. 14, 2012

(54) RESOURCE ALLOCATION FOR VIDEO PLAYBACK

(75) Inventors: Tero Rintaluoma, Oulu (FI); Olli Silvén, Oulu (FI)

(73) Assignee: GOOGLE INC., Mountain View, CA (US)

(21) Appl. No.: 13/315,943

(22) Filed: Dec. 9, 2011

(30) Foreign Application Priority Data
Dec. 13, 2010 (FI) 20106313

(51) Int. Cl. G06F 15/173

(52) U.S. Cl. 709/226

(57) ABSTRACT

An apparatus, a method, and a computer program implementing resource allocation for video playback are disclosed. First, information of a video sequence is obtained (902), and resource estimate for the video sequence is created (904) utilizing the obtained information. Next, resources are allocated (906) according to the resource estimate, and the video sequence is played (908) back with the allocated resources.

### CROSS-REFERENCE TO RELATED APPLICATION

This application claims priority to FI Application No. 20106313, filed Dec. 13, 2010, which is incorporated herein by reference in its entirety.

### TECHNICAL FIELD

The invention relates to an apparatus, a method, and a computer program implementing resource allocation for video playback.

### BACKGROUND

Digital video processing is a rapidly expanding field of technology. Processing platforms vary widely: from portable computers to portable mobile phones, for example. Further sophistication is desirable, also in view of the energy consumption, and, consequently, battery resource usage.

### SUMMARY

The present invention seeks to provide an improved apparatus, method, and computer program implementing resource allocation for video playback.

According to an aspect of the present invention, there is provided an apparatus as specified in claim 1.

According to another aspect of the present invention, there is provided a method as specified in claim 6.

According to another aspect of the present invention, there is provided a computer program as specified in claim 11.

### BRIEF DESCRIPTION OF THE DRAWINGS

Embodiments of the present invention are described below, by way of example only, with reference to the accompanying drawings, in which:

FIG. 1 illustrates embodiments of an apparatus;

FIG. 2 illustrates system resource allocation for a video application;

FIG. 3 illustrates influence of bitrate to computational complexity on ARM Cortex-A8 processor;

FIG. 4 illustrates decoding speed-up on multi-core processors;

FIG. 5 illustrates an example of how processing platform can operate on different voltage and frequency levels by utilizing dynamic voltage and frequency scaling (DVFS);

FIG. 6 illustrates a video application utilizing two CPUs in a multi-core platform;

FIG. 7 illustrates a video application running on a platform where 30% of video processing is done on CPU and 70% on Application Specific Processor (ASP);

FIG. 8 illustrates a video application running on platform that utilizes hardware acceleration, wherein 10% of video processing is done on CPU and rest is done on HW accelerator; and

FIG. 9 illustrates a method.

### DETAILED DESCRIPTION

The following embodiments are exemplary. Although the specification may refer to “an” embodiment in several locations, this does not necessarily mean that each such reference is to the same embodiment(s), or that the feature only applies to a single embodiment. Single features of different embodiments may also be combined to provide other embodiments.

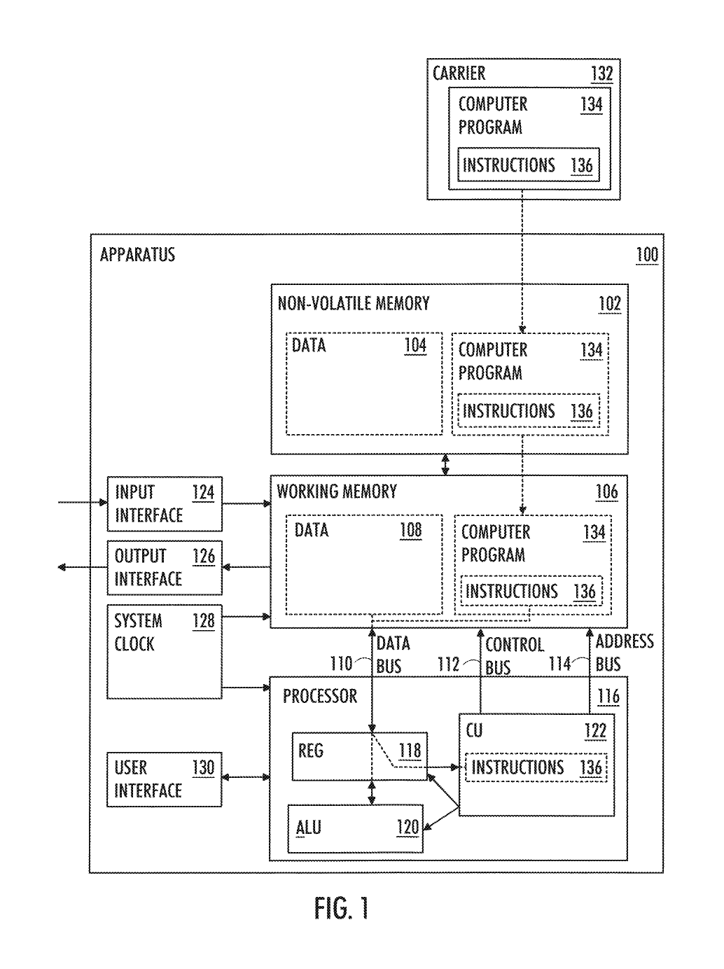

FIG. 1 illustrates embodiments of an apparatus 100. FIG. 1 only shows some elements whose implementation may differ from what is shown. The connections shown in FIG. 1 are logical connections; the actual physical connections may be different. Interfaces between the various elements may be implemented with suitable interface technologies, such as a message interface, a method interface, a sub-routine call interface, a block interface, or any means enabling communication between functional sub-units. It should be appreciated that the apparatus 100 may comprise other parts. However, such other parts may be irrelevant to the actual invention and, therefore, they need not be discussed in more detail here. It is also to be noted that although some elements are depicted as separate ones, some of them may be integrated into a single physical element. The specifications of the apparatus 100 may develop rapidly. Such development may require extra changes to an embodiment. Therefore, all words and expressions should be interpreted broadly, and they are intended to illustrate, not to restrict, the embodiments.

The apparatus 100 may be a (part of a) digital image processing apparatus, and comprises at least a video decoder decoding an encoded video sequence. Additionally, the apparatus 100 may comprise a video encoder producing an encoded video sequence. The video encoder/decoder (codec) may operate according to a video compression standard. Such apparatuses 100 include various subscriber terminals, user equipment, and other similar portable equipment, with or without a digital camera. However, the apparatus 100 is not limited to these examples, but it may be embedded in any electronic equipment where the described analysis may be implemented. The subscriber terminal may refer to a portable computing device. Such computing devices include wireless mobile communication devices operating with or without a subscriber identification module (SIM), including, but not limited to, the following types of devices: mobile phone, smartphone, personal digital assistant (PDA), handset. A wireless connection may be implemented with a wireless transceiver operating according to the GSM (Global System for Mobile Communications), WCDMA (Wideband Code Division Multiple Access), WLAN (Wireless Local Area Network) or Bluetooth® standard, or any other suitable standard/non-standard wireless communication means.

The apparatus 100 comprises a processor 116. The processor 116 is configured to obtain information of a video sequence, and to create resource estimate for the video sequence utilizing the obtained information. The processor 116 is also configured to allocate resources according to the resource estimate and to playback the video sequence with the allocated resources.

Next, we will describe the structure of the apparatus 100 in more detail, and, upon this, we will describe the processing of the video sequence in more detail.

The apparatus 100 may be an electronic digital computer, which may comprise, besides the processor 116, a working memory 106, and a system clock 128. Furthermore, the computer 100 may comprise a number of peripheral devices. In FIG. 1, some peripheral devices are illustrated: a non-volatile memory 102, an input interface 124, an output interface 126, and a user interface 130 (such as a pointing device, a keyboard, a display, a touch screen etc.).

Naturally, the computer 100 may comprise a number of other peripheral devices, not illustrated here for the sake of clarity.

The user interface 130 may be used for user interaction: a user may manipulate video playback software with the user interface 130, and the video sequence may be shown to the user with the user interface 130. Alternatively, or additionally, the video sequence may be outputted through the output interface 126. The output interface 126 is capable of outputting data even to another apparatus or a system such as an external display (a flat screen television, for example), i.e. the output interface 126 may be a communications interface, operating in a wired or wireless fashion, for example.

The system clock 128 constantly generates a stream of electrical pulses, which cause the various transferring operations within the computer 100 to take place in an orderly manner and with specific timing.

Depending on the processing power needed, the computer 100 may comprise several (parallel) processors 116, or the required processing may be distributed amongst a number of computers 100. The computer 100 may be a laptop computer, a personal computer, a server computer, a mainframe computer, or any other suitable computer. As the processing power of portable communications terminals, such as mobile phones, is constantly increasing, the apparatus 100 functionality may be implemented into them as well.

In some cases, it may be so that there really is one physical apparatus 100 for implementing the embodiments. But, this is just one option. The apparatus 100 may be implemented as a single computer, a distributed apparatus, a group of computers implementing the structure and functionality of the apparatus 100, or a group of distributed parts implementing the structure and functionality of the apparatus 100.

It is to be noted that the apparatus 100 functionality may be implemented, besides in computers, in other suitable data processing equipment as well. The implementation of the apparatus 100 functionality may also comprise both specific equipment, such as application specific processors, and general equipment, such as microprocessors.

The input interface 124 may be used to bring the video sequence into the apparatus 100.

The term ‘processor’ refers to a device that is capable of processing data. The processor 116 may comprise an electronic circuit or electronic circuits implementing the required functionality, and/or a microprocessor or microprocessors running a computer program 134 implementing the required functionality. When designing the implementation, a person skilled in the art will consider the requirements set for the size and power consumption of the apparatus 100, the necessary processing capacity, production costs, and production volumes, for example. The electronic circuit may comprise logic components, standard integrated circuits, application-specific integrated circuits (ASIC), and/or other suitable electronic structures.

The microprocessor 116 implements functions of a central processing unit (CPU) on an integrated circuit. The CPU 116 is a logic machine executing a computer program 134, which comprises program instructions 136. The program instructions 136 may be coded as a computer program using a programming language, which may be a high-level programming language, such as C, or Java, or a low-level programming language, such as a machine language, or an assembler. The CPU 116 may comprise a set of registers 118, an arithmetic logic unit (ALU) 120, and a control unit (CU) 122. The control unit 122 is controlled by a sequence of program instructions 136 transferred to the CPU 116 from the working memory 106. The control unit 122 may contain a number of microinstructions for basic operations. The implementation of the microinstructions may vary, depending on the CPU 116 design. The microprocessor 116 may also have an operating system (a general purpose operating system, a dedicated operating system of an embedded system, or a real-time operating system, for example), which may provide the computer program 134 with system services.

There may be three different types of buses between the working memory 106 and the processor 116: a data bus 110, a control bus 112, and an address bus 114. The control unit 122 uses the control bus 112 to set the working memory 106 in two states, one for writing data into the working memory 106, and the other for reading data from the working memory 106. The control unit 122 uses the address bus 114 to send to the working memory 106 address signals for addressing specified portions of the memory in writing and reading states. The data bus 110 is used to transfer data 108 from the working memory 106 to the processor 116 and from the processor 116 to the working memory 106, and to transfer the instructions 136 from the working memory 106 to the processor 116.

The working memory 106 may be implemented as a random-access memory (RAM), where the information is lost after the power is switched off. The RAM is capable of returning any piece of data in a constant time, regardless of its physical location and whether or not it is related to the previous piece of data. The data may comprise video sequence, any temporary data needed during the analysis, program instructions etc.

The non-volatile memory 102 retains the stored information even when not powered. Examples of non-volatile memory include read-only memory (ROM), flash memory, magnetic computer storage devices such as hard disk drives, and optical discs. As is shown in FIG. 1, the non-volatile memory 102 may store both data 104 and a computer program 134 comprising program instructions 136.

An embodiment provides a non-transitory computer readable storage medium 132 storing a computer program 134, comprising program instructions 136 which, when loaded into an apparatus 100, cause the apparatus 100 obtain information of a video sequence, to create resource estimate for the video sequence utilizing the obtained information, to allocate resources according to the resource estimate, and to playback the video sequence with the allocated resources.

The computer program 134 may be in source code form, object code form, or in some intermediate form. The computer program 134 may be stored in a carrier 132, which may be any entity or device capable of carrying the program to the apparatus 100. The carrier 132 may be implemented as follows, for example: the computer program 134 may be embodied on a record medium, stored in a computer memory, embodied in a read-only memory, carried on an electrical carrier signal, carried on a telecommunications signal, and/or embodied on a software distribution medium. In some jurisdictions, depending on the legislation and the patent practice, the carrier 132 may not be the telecommunications signal.

FIG. 1 illustrates that the carrier 132 may be coupled with the apparatus 100, whereupon the program 134 comprising the program instructions 136 is transferred into the non-volatile memory 102 of the apparatus 100. The program 134 with its program instructions 136 may be loaded from the non-volatile memory 102 into the working memory 106. During running of the program 134, the program instructions 136 are transferred via the data bus 110 from the working memory 106 into the control unit 122, wherein usually a portion of the instructions 136 resides and controls the operation of the apparatus 100.

There are many ways to structure the program 134. The operations of the program may be divided into functional modules, sub-routines, methods, classes, objects, applets, macros, etc., depending on the software design methodology and the programming language used. In modern programming environments, there are software libraries, i.e. compilations of ready made functions, which may be utilized by the program for performing a wide variety of standard operations.

The computer program 134 may comprise four separate functional entities (which may be divided into modules, subroutines, methods, classes, objects, applets, macros, etc.):
a first entity to obtain information of a video sequence;
a second entity to create resource estimate for the video sequence utilizing the obtained information;
a third entity to allocate resources according to the resource estimate; and
a fourth entity to playback the video sequence with the allocated resources.

Besides these basic entities, there may be a number of other, supplementary entities. Data 104/108, which comprises video sequence, may be brought into the working memory 106 via the non-volatile memory 102 or via the input interface 124. For this operation, there may be a further software entity. The data 104 may have been brought into the non-volatile memory 102 via a memory device (such as a memory card, an optical disk, or any other suitable non-volatile memory device) or via a telecommunications connection (via Internet, or another wired/wireless connection). The input interface 124 may be a suitable communication bus, such as USB (Universal Serial Bus) or some other serial/parallel bus, operating in a wireless/wired fashion. The input interface 124 may be directly coupled with an electronic system possessing the video sequence, or there may be a telecommunications connection between the input interface 124 and the video sequence recording or storing system. A wireless connection may be implemented with a wireless transceiver operating according to the GSM (Global System for Mobile Communications), WCDMA (Wideband Code Division Multiple Access), WLAN (Wireless Local Area Network) or Bluetooth® standard, or any other suitable standard/non-standard wireless communication means.

To conclude, the apparatus 100 is capable of playing back the video sequence, and the video sequence may be brought into the apparatus 100 by any means for transferring data.

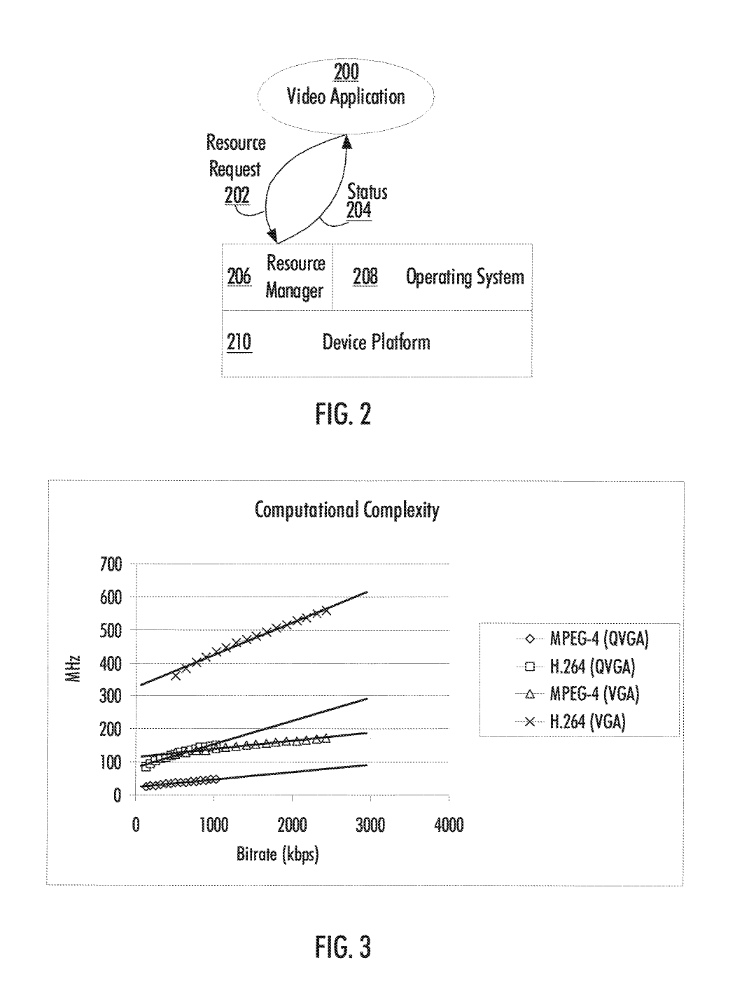

FIG. 2 illustrates system resource allocation for a video application 200 running on a specific device platform 210, such as the apparatus 100 described with reference to FIG. 1. In effect, a new algorithm and method has been developed to estimate platform resource needs in the video (playback) application 200. Algorithm may create resource estimate based on video characteristics such as video format, bitrate, frame rate, image size and complexity factor. Complexity factor is a factor that describes relative complexity of the video format against a known baseline. Benefit of such estimate is that some kind of resource manager (RM) may allocate resources based on the estimated value beforehand and, consequently, retain certain quality of service. Knowing resource needs beforehand improves energy efficiency in systems capable of using power saving features such as clock gating, dynamic voltage, and frequency scaling (DVFS), because resources do not need to be allocated for the worst case scenario.

When user of the video application 200 selects video clip for playback, the application 200 may read video format, bitrate, image size and frame rate information from the file container or from streaming protocol descriptors such as SDP. Next, the video application 200 may create an estimate of the resource usage based on the developed algorithm and pass that information 202 to the resource manager 206, or operating system 208. Resource manager 206 allocates the requested resources and returns status information 204 to the application 200 as illustrated in FIG. 2. This way it is possible to keep the quality of service (QoS) and the quality of experience (QoE) in the best level.

If the amount of needed resources is small, resource manager 206 may, for example, lower the CPU clock frequency by using DVFS or, in multi-core systems, shut down CPU cores that are not needed. Existing resource management methods do not take advantage of the prior knowledge of application's resource usage but rely on dynamic control in runtime. For this purpose, the new method has been developed to estimate resource needs of the video decoding application.

The method uses different complexity factors for different video standards and profiles in a known platform 210. These complexity factors may be selected on a platform basis.

For example, MPEG-4 Simple Profile may be used as a baseline in OMAP 3430 platform. In this case, complexity factor cf=1 is given for MPEG-4 and cf=3.27 for H.264 baseline.

Required computing cycles can be calculated from equation

MHz=cf*(0.023x+0.0034y−4.268), (1)

where x is number of macroblocks per second and y is the used bitrate. Accuracy of the method depends on used input sequence and video characteristics. When using a “shields” test sequence, which has been used to derive the equation, the estimate gives 195.14 MHz for H.264 CIF 30 fps video and actual measured value is 195 MHz.

The need for resource management (RM) features is urgent nowadays especially in energy efficient multi-core and many-core systems. For example, the Multicore Association has proposed an API (Application Programming Interface) for resource management. For this reason proposed method is relevant in future platforms that use RM to maintain the required QoS and QoE.

In video coding, single image is usually divided to macroblocks consisting 16×16 pixel luminance blocks and sub-sampled 8×8 pixel chrominance blocks. These macroblocks are one of the basic units in video compression. The resolution and frame rate naturally determine how many macroblocks are processed in a second. The more macroblocks per second are processed, the more execution cycles are consumed in video compression or decompression.

FIG. 3 shows that the same video format consumes more cycles for VGA resolution video than for QVGA resolution video with the same bitrate. On the other hand, it can be seen that computing power increases linearly with function of bitrate and the slope is almost at the same level in all cases. Additionally, FIG. 3 illustrates that H.264 is about 3.3 times more complex than MPEG-4 regardless of resolution or bitrate. This can be generalized for other video formats so that each of them can be described by a constant complexity factor compared to the known baseline. By using these facts, we can build a linear equation that estimates needed computing cycles when we know at least the format/implementation specific complexity factor (cf), bitrate (x) and number of macroblocks per second (y). An example of such an equation in a single core system is

MHz=cf*(0.023x+0.0034y−4.268) (2).

The linear lines have been drawn in FIG. 3 for different resolutions and standards.

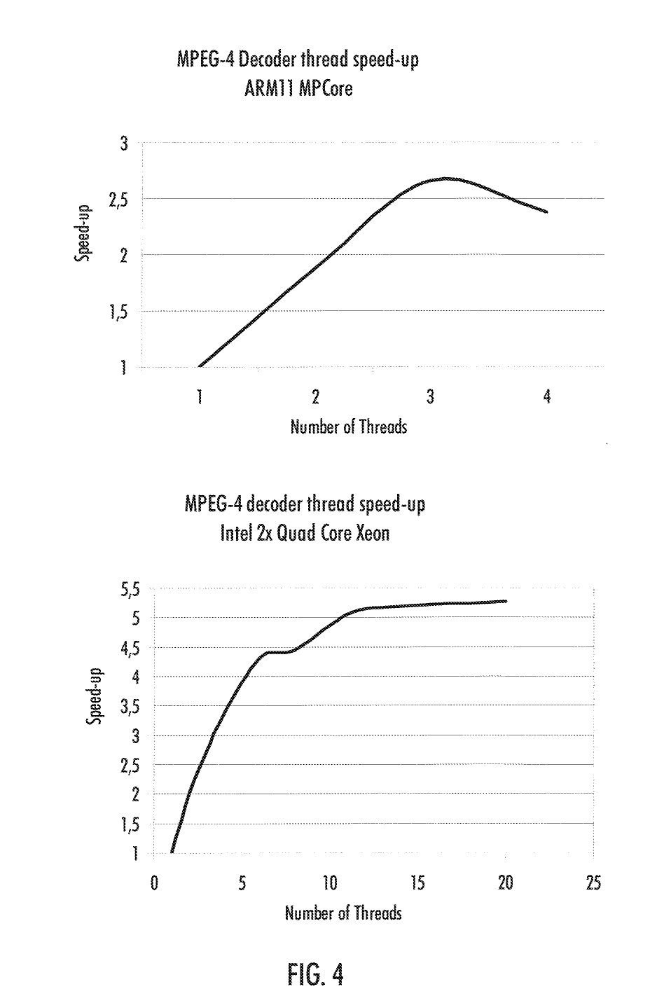

FIG. 4 shows how the execution time is reduced on multi core platforms when the video decoder uses several threads to process data. For this reason complexity estimation model must take number of available cores in to account too. For example, the equation can be expanded to have thread speed-up factor (tsf):

MHz=tsf*cf*(0.023x+0.0034y−4.268) (3).

It should be noticed that model does not need to be linear but can also be non-linear and more complex. If a more accurate model is needed, each video format may have its own equation for modeling its behavior and resource needs on the platform. In this case, complexity factor may not be needed. Following example equations illustrate this case:

(Format A) MHz=tsf*(a₁x²+b₁×+c₁y³−d₁y+e₁) (4)

(Format B) MHz=tsf*(a₂x²+b₂x+c₂−d₂y+e₂) (5).

Another way to obtain resource usage estimate is to store known test vector characteristics such as image size, bitrate, frame rate, video format and corresponding resource needs into a table which may be used as a reference. When new video sequence is going to be played, its image size, bitrate, framerate and video format is compared to a reference data and closest matching resource needs are selected.

Before the complexity estimation model may operate in the best way, it needs to be calibrated for a given execution platform. This may be done, for example, running manually some video test sequences with different formats, resolutions, bitrates and so on to find out correct video processing performances. This step is only needed when model is ported to new platform. Calibration might be done manually, semi-automatically or automatically to anchor the developed model to a new platform.

Following steps illustrate the utilization of the developed resource estimation method:
1) Video playback application reads available information from some container such as file format, networking protocol metadata or other source. Additional information can be obtained by decoding sequence headers of the actual video bit stream or by reading system information such as number of available processor cores.
2) Application creates resource estimate for current video sequence based on information read in the first stage and passes it to the developed estimation model which returns the estimate.

Complexity estimation model can compute the estimate based on, for example, following information:
picture size: bigger images need more computing cycles;
bitrate: higher bitrate requires more computing cycles;
frame rate: higher frame rate requires more computing cycles;
video coding format: e.g. H.264 requires typically more cycles than MPEG-4;
number of available cores: video codec capable of parallel execution may take advantage of several processors; and
complexity factor: describes how much more complex some video format is compared to a known baseline.
3) Estimate is passed to resource manager or operating system. It can contain, for example, needed clock cycles on application processor or memory requirements.
4) Resource manager checks if there are enough free resources and allocates them and returns a status to the application. If there are not enough resources, application can inform it to user.

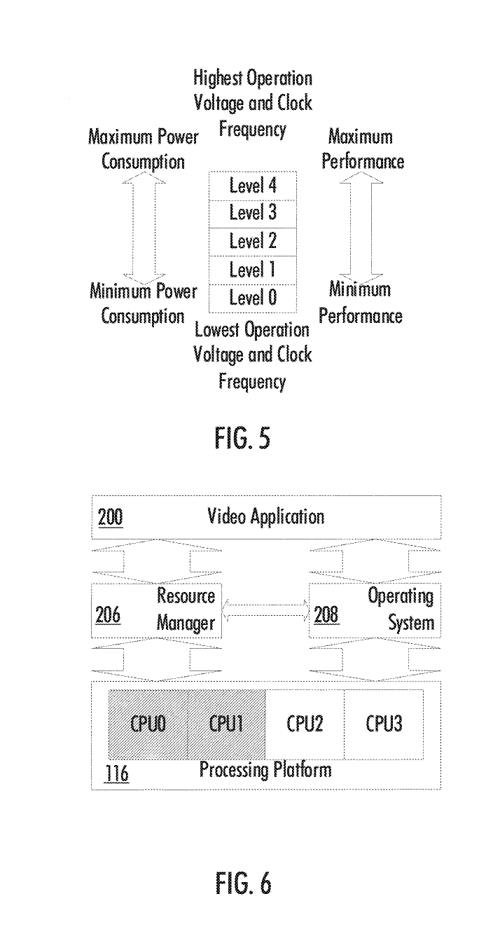

FIG. 5 illustrates how some processors may operate with different voltage and frequency levels. This way it is possible to make energy and performance tradeoffs to conserve energy when full processing power is not needed. Because frequency steps on processors are usually around 100 MHz, complexity estimator can easily provide accurate enough estimate of needed computing cycles for RM to select correct operating frequency.

For example, platform is operating on voltage and frequency level 1 when user selects video sequence with moderate resolution and bitrate (QVGA@30 fps, 512 kbps) for playback. Video application uses complexity estimator to create resource estimate for that video and passes the estimate to the RM. RM allocates resources and raises operating voltage and frequency to level 3 before the actual playback starts. This has several advantages: first, operation level does not need to rise to level 5 (full power) and this way energy is saved. Secondly, user does not need to wait the processing platform to find out correct operating level during the first seconds of video playback. This way better user experience is achieved, and playback starts smoothly without missing frame display deadlines.

FIG. 6 illustrates how the video application 200 may interact with the resource manager 206 and the operating system 208. Resource manager 206 and operating system 208 may exchange information if needed, and both of them may control processing hardware 116.

The video application 200 may start playback and first read information from, for example, file format. After that, a complexity estimation model calculates how many CPU cycles are approximately needed and informs the resource manager 206. In this case not all CPUs are needed for video application and only two of them need to be active (CPUO and CPU1). In this kind of multi-core platform energy can be conserved because CPU2 and CPU3 may remain in sleeping mode.

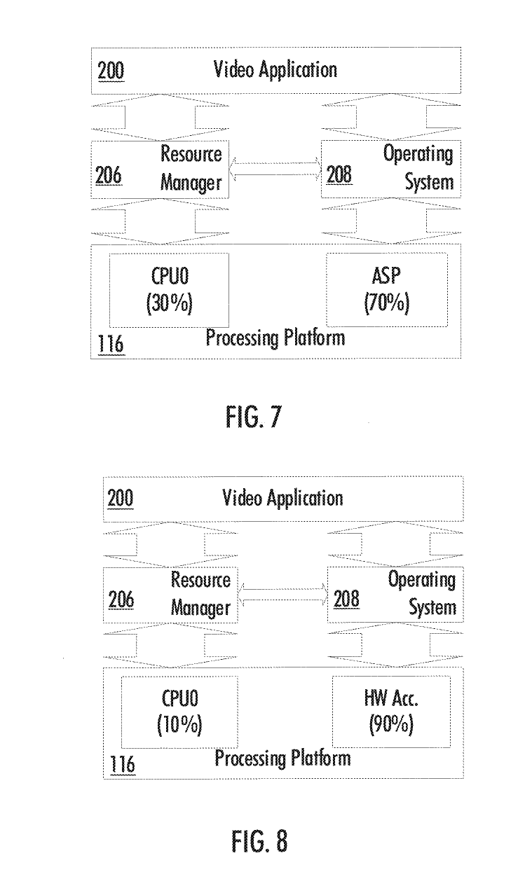

In FIG. 7 the situation is similar to that presented in FIG. 6, except that in FIG. 7 the processing platform 116 has an Application Specific Processor (ASP) for video acceleration in addition to the traditional CPU. According to complexity estimation model, operating frequencies may be set to optimal level and some parts of video are processed on CPU and the rest is processed by ASP. In FIG. 7, the video application 200 is running on the platform 116 where 30% of video processing is done on CPU and 70% on ASP.

FIG. 8 shows that the complexity estimator may be used for the video application 200 utilizing dedicated hardware accelerators in addition to CPU. Again using estimator, the best operation voltage and frequency may be selected. In FIG. 8, the video application 200 is running on the platform 116 that utilizes hardware acceleration. In this case 10% of video processing is done on CPU and the rest is done on HW accelerator.

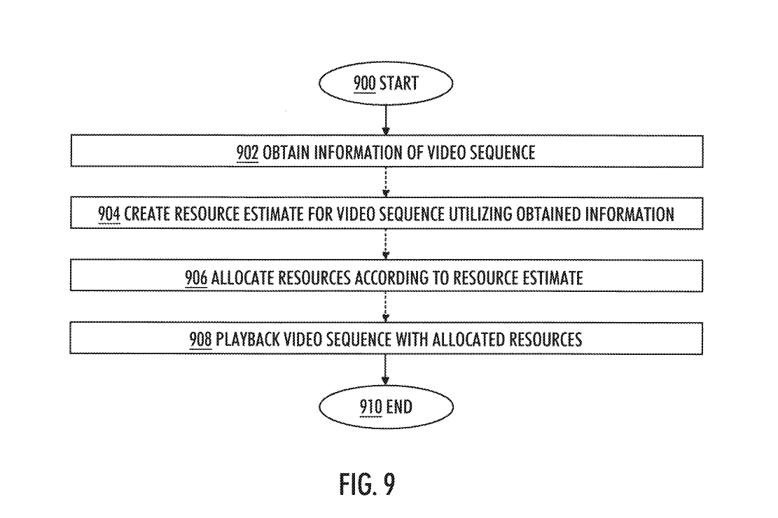

Next, with reference to FIG. 9, a method performed in an electronic apparatus is explained. The method may be implemented as the apparatus 100 or the computer program 134 comprising program instructions 136 which, when loaded into the apparatus 100, cause the apparatus 100 to perform the process to be described. The embodiments of the apparatus 100 may also be used to enhance the method, and, correspondingly, the embodiments of the method may be used to enhance the apparatus 100.

The steps are in no absolute chronological order, and some of the steps may be performed simultaneously or in an order differing from the given one. Other functions can also be executed between the steps or within the steps and other data exchanged between the steps. Some of the steps or part of the steps may also be left out or replaced by a corresponding step or part of the step. It should be noted that no special order of operations is required in the method, except where necessary due to the logical requirements for the processing order.

The method starts in 900. In 902, information of a video sequence is obtained.

Optionally, obtaining the information in 902 comprises at least one of the following: reading available information from some container such as file format, networking protocol metadata or other source, decoding sequence headers of the video sequence, reading system information such as a number of available processor cores.

In 904, resource estimate for the video sequence is created utilizing the obtained information.

Optionally, the resource estimate is created in 904 with at least one of the following parameters: picture size in the video sequence, bitrate of the video sequence, frame rate of the video sequence, video coding format of the video sequence, number of available processor cores, a complexity factor describing how much more complex some video format, or a different profile of the video format, is compared to a known baseline.

Optionally, the resource estimate is created in 904 as a number of needed clock cycles on an application processor, as a needed bandwidth for data transfers, or as memory requirements for the application processor.

In 906, resources are allocated according to the resource estimate. In 908, the video sequence is played back with the allocated resources.

Optionally, the resources according to the resource estimate are allocated in 906 in such a manner that power saving features of the apparatus are utilized, and the video sequence with the allocated resources is played back in 908 in such a manner that the power saving features of the apparatus are utilized, wherein the power saving features include at least one of the following: clock gating, dynamic voltage, and frequency scaling. The method ends in 910.

It will be obvious to a person skilled in the art that, as technology advances, the inventive concept can be implemented in various ways. The invention and its embodiments are not limited to the examples described above but may vary within the scope of the claims.

In one embodiment, an apparatus comprises a processor configured to: obtain information of a video sequence; create resource estimate for the video sequence utilizing the obtained information; allocate resources according to the resource estimate; and playback the video sequence with the allocated resources.

In one aspect of this embodiment, the apparatus comprising a processor is further configured to obtain the information by at least one of the following: by reading available information from some container such as file format, networking protocol metadata or other source, by decoding sequence headers of the video sequence, by reading system information such as a number of available processor cores.

In another aspect of this embodiment, the apparatus comprising a processor is further configured to create the resource estimate with at least one of the following parameters: picture size in the video sequence, bitrate of the video sequence, frame rate of the video sequence, video coding format of the video sequence, number of available processor cores, a complexity factor describing how much more complex some video format, or a different profile of the video format, is compared to a known baseline.

In another aspect of this embodiment, the apparatus comprising a processor is further configured to create the resource estimate as a number of needed clock cycles on an application processor, as a needed bandwidth for data transfers, or as memory requirements for the application processor.

In another aspect of this embodiment, the apparatus comprising a processor is further configured to allocate the resources according to the resource estimate in such a manner that power saving features of the apparatus are utilized, and playback the video sequence with the allocated resources in such a manner that the power saving features of the apparatus are utilized, wherein the power saving features include at least one of the following: clock gating, dynamic voltage, and frequency scaling.

In another embodiment, a method performed in an electronic apparatus, comprises: obtaining information of a video sequence; creating resource estimate for the video sequence utilizing the obtained information; allocating resources according to the resource estimate; and playing back the video sequence with the allocated resources.

In one aspect of this embodiment, obtaining the information comprises at least one of the following: reading available information from some container such as file format, networking protocol metadata or other source, decoding sequence headers of the video sequence, reading system information such as a number of available processor cores.

In another aspect of this embodiment, the resource estimate is created with at least one of the following parameters: picture size in the video sequence, bitrate of the video sequence, frame rate of the video sequence, video coding format of the video sequence, number of available processor cores, a complexity factor describing how much more complex some video format is compared to a known baseline.

In another aspect of this embodiment, the resource estimate is created as a number of needed clock cycles on an application processor, or as memory requirements for the application processor.

In another aspect of this embodiment, the resources according to the resource estimate are allocated in such a manner that power saving features of the apparatus are utilized, and the video sequence with the allocated resources is played back in such a manner that the power saving features of the apparatus are utilized, wherein the power saving features include at least one of the following: clock gating, dynamic voltage, and frequency scaling.

In another embodiment, a computer program comprising program instructions which, when loaded into an apparatus, cause the apparatus to perform the process of any of the preceding embodiments.

What is claimed is:

1. An apparatus, comprising:
a memory; and
a processor configured to execute instructions stored in the memory to:
obtain information from a video sequence;
create a resource estimate for the video sequence utilizing the obtained information;
allocate at least one resource according to the resource estimate; and
playback the video sequence with the at least one resource.
